(19) United States
(12) Patent Application Publication
(10) Pub. No.: US 2013/0182387 A1
(43) Pub. Date: Jul. 18, 2013

(54) ACCESSORY SYSTEM FOR PORTABLE ELECTRONIC COMPUTING DEVICES

(71) Applicants: Shadi Mere, Ann Arbor, MI (US); Royce Channey, Ann Arbor, MI (US); Kyle Walworth, Ann Arbor, MI (US)

(72) Inventors: Shadi Mere, Ann Arbor, MI (US); Royce Channey, Ann Arbor, MI (US); Kyle Walworth, Ann Arbor, MI (US)

(21) Appl. No.: 13/351,154

(22) Filed: Jan. 16, 2012

(51) Int. Cl. G06F 1/16

(52) U.S. Cl. 361/679.41; 361/679.55

(57) ABSTRACT

An accessory system for a portable electronic computing device includes a body, a dock integral with the body for receiving and securing the portable electronic computing device, and a protective case for enclosing at least a portion of the portable electronic computing device when the portable electronic computing device is not attached to the body. The dock is sized and shaped to receive the portable electronic computing device while the portable electronic computing device is in said protective case.

### FIELD OF THE INVENTION

The invention relates generally to mobile phones, electronic readers and tablets devices, and more particularly to accessory attachments for such devices.

### BACKGROUND OF THE INVENTION

The market for portable electronic computing devices, such as mobile smartphones, tablet-style personal computers, portable music players, and the like, continues to grow. As the portable electronic computing devices become more capable, the need for a consumer to own multiple portable electronic computing devices is reduced. It is common for a consumer to replace a plurality of portable electronic computing devices with a single newer device that performs at least all of the functions of the plurality of devices being replaced. Though the replaced or obsolete portable electronic computing devices have diminished utility over the newer devices, the replaced or obsolete portable electronic computing devices still adequately perform the functions for which they were designed. However, no significant market exists for used, replaced or obsolete portable electronic computing devices, and often fully functional but technologically dated portable electronic computing devices are simply discarded by the owner. It is therefore desirable to improve the long-term usability and utility of portable electronic computing devices.

The accessory market for portable electronic computing devices is also robust. Available accessories typically include protective covers or cases in which to store the portable electronic computing device, protective and/or decorative films or covers to protect the visual display or exterior of the portable electronic computing device, and headphones and headphone controls to control the volume and/or media selection of the device.

Known protective cases are designed only to protect the portable electronic computing device against scratches or moderate impacts. However, the known protective cases do not include any integral connection to the portable electronic computing device, and do not provide any method for controlling or operating the portable electronic computing device, or any internal functions thereof. Similarly, known protective films allow for device personalization and provide a certain level of impact and scratch resistance, particularly when applied to visual displays of the portable electronic computing devices, but provide no functional improvement or interface with the portable electronic computing device. Other accessories may include certain integrated control functions, but such integrated control functions are limited to controls that affect the performance of the accessory. For example, an accessory headphone may include integral controls, but the integral controls are limited to functions related to the headphones, such as volume control or control of other audio functions. The integral controls do not provide an interface to the portable electronic computing device itself.

Additionally, to switch between accessories, a user may have to remove a known protective case. For example, a personal music player may have an installed protective covering. However, to dock the personal music player to an external speaker system using an integral connector may require removal of the known protective case. Therefore, it is often difficult to switch between user modes of the personal electronic computing device.

Instead, portable electronic computing devices include integral controls for managing and manipulating functions on the portable electronic computing device. For example, each portable electronic computing device may have integral buttons to control functions such as volume, menu navigation and search features. Advanced portable electronic computing devices may also include touch screens to control features, functions and application navigation functions. Due to the portable nature of the portable electronic computing devices, the integral buttons are often small, which creates difficulty for some users. Moreover, the touch screen functions require direct contact with exposed fingers. A person wearing gloves is not able to use the touch screen without removing the gloves.

It is therefore desirable to develop accessories for portable electronic computing devices that include integral control functions for controlling and using the portable electronic computing device. It is further desirable that the accessories for portable electronic computing devices be easy to use, and that the accessories overcome disadvantages of the integral controls of the portable electronic computing device.

### SUMMARY OF THE INVENTION

An accessory system for a portable electronic computing device has surprisingly been discovered. The accessory system for a portable electronic computing device includes a body, a dock integral with the body for receiving and securing the portable electronic computing device, and a protective case for enclosing at least a portion of the portable electronic computing device when the portable electronic computing device is not attached to the body. The dock is sized and shaped to receive the portable electronic computing device while the portable electronic computing device is in said protective case.

In one embodiment, the accessory system includes a secondary coil within the body in electrical communication with the portable electronic computing device. A primary coil may induce a current within the secondary coil to provide power to the portable electronic computing device.

In another embodiment, the accessory system may include at least one user interface, such as one of a button, a rotary knob, a capacitive input device, a voice input device, a video or optical input device, a wireless input device, and a touchpad in signal communication with the portable electronic computing device.

In another embodiment, the accessory system may include at least one output device, such as one of an aural output, a visual output, and a haptic output, in signal communication with the portable electronic computing device.

In still another embodiment, the accessory system may include a battery in electronic communication with the portable electronic computing device. The battery may be internal or external to the body, as desired.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a front perspective view of an accessory system according to an embodiment of the invention;

FIG. 2 is an exploded perspective view of the accessory system according to an embodiment of the invention; and

FIG. 3 is a block diagram of the accessory system according to an embodiment of the invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

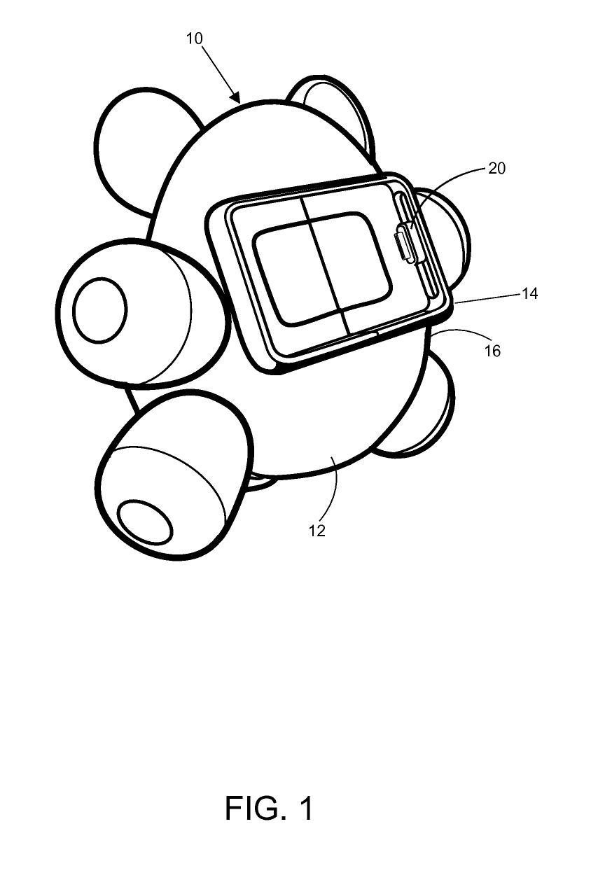

An accessory system 10 is shown in FIG. 1. The accessory system 10 includes a body 12 having a dock 14 integrally formed thereto. The body 12 may be any size, and is made of any material that provides shock or impact protection, such as a resilient plastic, foam or rubber. Alternatively, the body 12 may be formed as a stuffed toy having a wear-resistant outer skin in combination with a soft filler material. However, as shown in FIG. 1, the dock 14 is usually sized to fit within the outer perimeter 16 of the body 12.

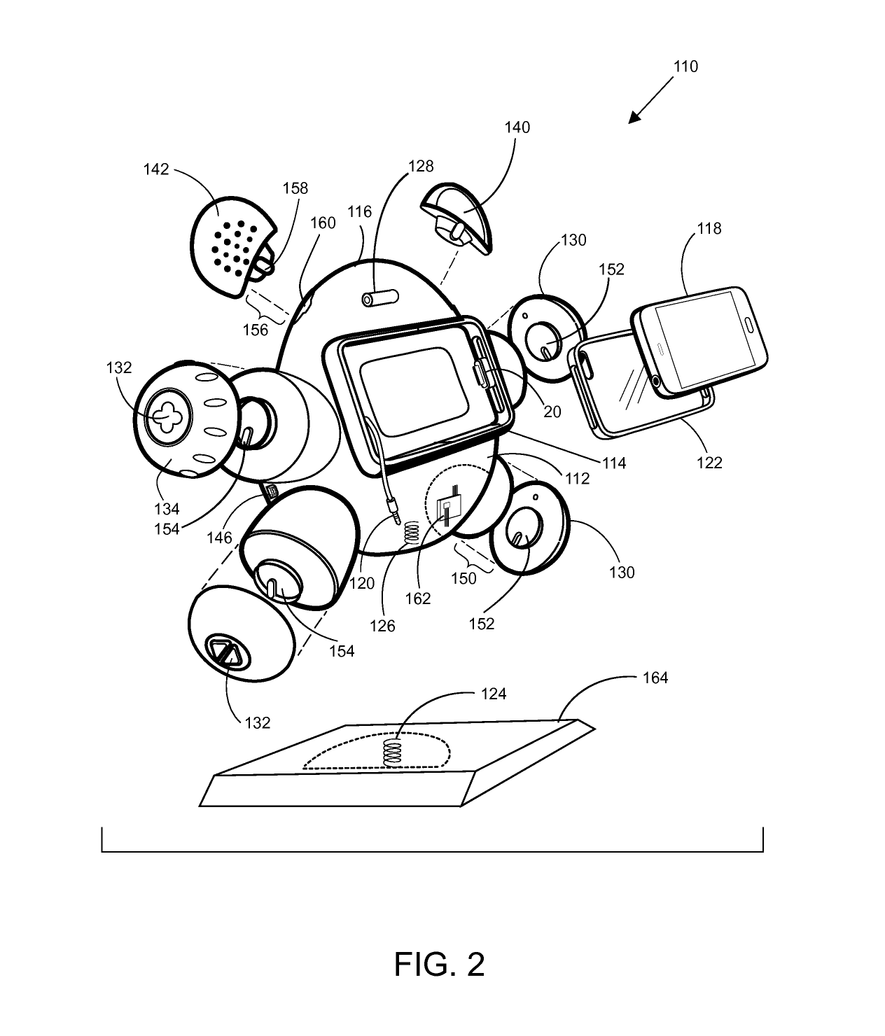

The dock 14 is designed to receive, secure and conform to a portable electronic computing device 118 (shown in FIG. 2), or “PECD”, to the body 12. The accessory system 10 may be designed to receive any PECD 118 such as mobile smartphones, tablet-style personal computers, portable music players, and the like. The dock 14 may include a control interface 20. The control interface 20 utilized in accessory system 10 depends on the type and manufacturer of the PECD 118.

An accessory system 110 is shown in greater detail with reference to FIG. 2. The accessory system 110 of FIG. 2 includes a body 112 having a dock 114 integrally formed thereto. The dock 114 is designed to receive, secure and conform to the PECD 118. The body 112 may be any size. However, the dock 114 is usually sized to fit within the outer perimeter 116 of the body 112. In this way, when PECD 118 is received within the dock 114, both the dock 114 and the body 112 provide impact protection for the PECD 118. The dock 114 includes at least one control interface 20, 120 adapted to provide a signal interface to the PECD 118 for input, output, functional control, or some combination thereof.

The accessory system 110 may include a protective case 122. The protective case 122 is designed to receive and enclose the PECD 118 when the PECD 118 is not attached to the body 112 or the dock 114. However, the protective case 122 need not be removed from the PECD 118 to allow for insertion of the PECD 118 into the dock 114 on the body 112. Instead, the dock 114 is designed to receive and to conform to the PECD 118 both when the PECD 118 is enclosed in the protective case 122, and when the PECD 118 is not enclosed in the protective case 122. In this manner, the protective case 122 may be used to protect the PECD 118 when the PECD 118 is not attached to the accessory system 110, such as for everyday usage of the PECD 118. Advantageously, the protective case 122 need not be removed from the PECD 118 prior to insertion of the PECD 118 into the dock 114 because the dock 114 is sized and shaped to receive the PECD 118 both with and without the protective case 122, thereby allowing a user of the accessory system 110 to continuously utilize the protective case 122, both with and without the accessory system 110.

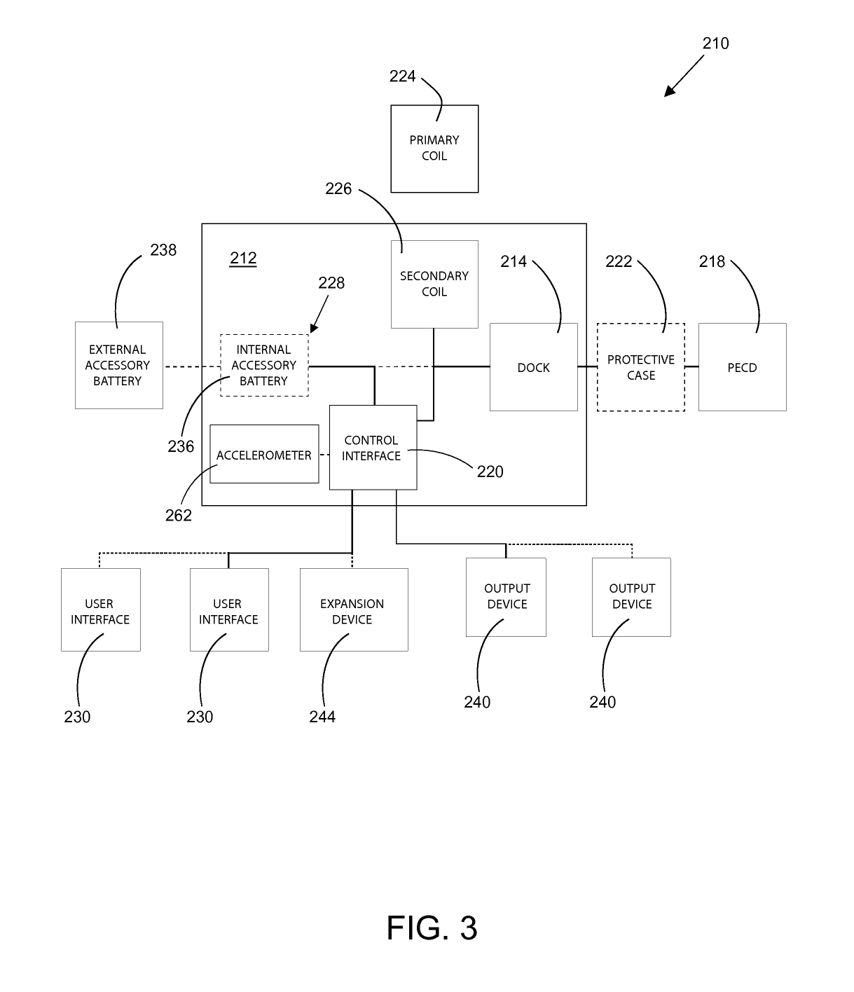

The accessory system 110 may include many advantageous features to enhance the usability of the PECD 118. For example, the accessory system may include an external power port 146 to allow for an external power source to provide power to the PECD 118. The accessory system 110 may further include a primary coil 124 and a secondary coil 126 to enable an inductive charging of the PECD 118. The secondary coil 126 may be integrally formed with the body 112 and may be electrically interconnected to the PECD 118 to both power the PECD 118 and to charge any internal batteries of the PECD 118. Additionally, the secondary coil 126 may be configured to charge any accessory battery 128 that is capable of electrical interconnection to the PECD 118. Inductive charging will be discussed in more detail with reference to FIG. 3 below. The primary coil 124 may be provided as an external fixture, such as a pad 164 or a stand for supporting the accessory system 110. The primary coil 124 interacts inductively with the secondary coil 126, such that a current in the primary coil 124 induces a current in the secondary coil 126, as is known in the art.

In one embodiment, the accessory system 110 may optionally include at least one user interface 130 in signal communication with the PECD 118, where the at least one user interface 130 is integrally formed with the body 112. The at least one user interface 130 are shown in FIG. 2 as a button 132 and a rotary knob 134. However, the at least one user interface 130 may also be formed as a capacitive input device, a voice input device, a video or optical input device, a wireless input device, a touchpad, or the like. Depending upon the type of user interface desired, the at least one user interface 130 may also be embedded within the body 112 to sense motion, direction, force and acceleration, such as with accelerometer 162 shown in FIG. 2. The at least one user interface 130 is in signal communication with the PECD 118, generally through the control interface 20 or the control interface 120, and may be used to provide external control input signals to the PECD 118, to control or implement any functionality of the PECD 118.

Similarly, the accessory system 110 may optionally include at least one output device 140 in signal communication with the PECD 118. The at least one output device 140 may be integrally formed with the body 112, and is in signal communication with the PECD 118, generally through the control interface 20 or the control interface 120. As one example, the at least one output device 140 may be in the form of a speaker 142. However, the at least one output device 140 may also be one of an aural output, a visual output such as a lamp or image, and a haptic output that provides sensory feedback such as a motion or a vibration.

The body 112 may be designed to include one or more standardized input interfaces 150 for receiving the at least one user interface 130. The standardized input interfaces 150 may include a male connector portion 152 and a female connector portion 154. It is understood that the male connector portion 152 may be formed as part of either the body 112 or the user interface 130, and that the female connector portion 154 similarly may be formed as part of either the body 112 or the user interface 130, as desired. By providing one or more standardized input interfaces 150, the body 112 may be configured for expansion as desired by a user of the accessory system 110, or as new user interface 130 designs or features become available.

Similarly, the body 112 may be designed to one or more standardized output interfaces 156 for receiving one or more output devices 140. The standardized output interfaces 156 may include a male connector portion 158 and a female connector portion 160. It is understood that the male connector portion 158 may be formed as part of either the body 112 or the output device 140, and that the female connector portion 160 similarly may be formed as part of either the body 112 or the output device 140, as desired. In this way, the body 112 may be configured for expansion or for addition of one or more output devices 140 as desired by a user of the accessory system 110, or as new output devices 140 become available.

As is apparent to one skilled in the art, it is understood that the standardized input interface 150 and the standardized output interface 156 need not be limited to male and female connection. Instead, as non-limiting examples, the standardized input interface 150 and the standardized output interface 156 may be any type of standardized connection, such as capacitive coupling, wireless coupling using any known frequency, and optical coupling.

Construction and operation of an accessory system 210 is generally shown with reference to the block diagram of FIG. 3. The accessory system 210 includes a body 212. The body 212 includes an integrally formed dock 214. The dock 214 is designed to receive, secure and conform to a portable electronic computing device (“PECD”) 218. The body 212 may be any size. However, the dock 214 is usually sized to fit within the outer perimeter of the body 212. In this way, when PECD 218 is received within the dock 214, both the dock 214 and the body 212 provide impact protection for the PECD 218. The dock 214 includes at least one control interface 220 in electrical communication with and adapted to provide a signal interface to the PECD 218 for input, output, functional control, or some combination thereof.

The accessory system 210 may include a protective case 222. The protective case 222 is designed to receive and enclose the PECD 218 when the PECD 218 is not attached to the body 212 or the dock 214. However, the protective case 222 need not be removed from the PECD 218 to allow for insertion of the PECD 218 into the dock 214 on the body 212. Instead, the dock 214 is designed to receive and to conform to the PECD 218 both when the PECD 218 is enclosed in the protective case 222, and when the PECD 218 is not enclosed in the protective case 222. In this manner, the protective case 222 may be used to protect the PECD 218 when the PECD 218 is not attached to the accessory system 210, such as for everyday usage of the PECD 218. Advantageously, the protective case 222 need not be removed from the PECD 218 prior to insertion of the PECD 218 into the dock 214 because the dock 214 is sized and shaped to receive the PECD 218 both with and without the protective case 222, thereby allowing a user of the accessory system 210 to continuously utilize the protective case 222, both with and without the accessory system 210.

The accessory system 210 may include many advantageous features to enhance the usability of the PECD 218. For example, the accessory system 210 may include a primary coil 224 and a secondary coil 226 to enable an inductive charging of the PECD 218. The secondary coil 226 may be integrally formed with the body 212 and may be electrically interconnected to the PECD 218 to both power the PECD 218 and to charge any accessory battery 228 of the PECD 218. Notably, the accessory system 210 may include any type of accessory battery 228, including an internal accessory battery 236 internal to the body 212 and an external accessory battery 238 external to the body 212. Thus, the secondary coil 226 may be configured to charge any accessory battery 228 that is capable of electrical interconnection to the PECD 218. The primary coil 224 may be provided as a fixture external the body 212 for supporting the accessory system 210. The primary coil 224 interacts inductively with the secondary coil 226, such that a current in the primary coil 224 induces a current in the secondary coil 226 for use in powering the PECD 218 or in charging the accessory battery 228, as is known in the art.

The accessory system 210 may optionally include at least one user interface 230 in signal communication with the PECD 218. The at least one user interface 230 may be integrally formed with the body 212. The at least one user interface 230 may be formed as one of a button, a rotary knob, a capacitive input device, a voice input device, a video or optical input device, a wireless input device, a touchpad, or the like. Depending upon the type of user interface desired, the at least one user interface 230 may also be embedded within the body 212 to sense motion, direction, force and acceleration, such as with accelerometer 262 shown in FIG. 3. The accessory system 210 may include any number of user interfaces 230, as desired. Each of the at least one user interface 230 is in signal communication with the PECD 218, generally through the control interface 220, and may be used to provide internal or external control input signals to the PECD 218, to control or implement any functionality the PECD 218.

Similarly, the accessory system 210 may optionally include at least one output device 240 in signal communication with the PECD 218. The at least one output device 240 may integrally formed with the body 212, and is in signal communication with the PECD 218, generally through the control interface 220. The at least one output device 240 may be one of an aural output, a visual output such as a lamp or image, and a haptic output that provides sensory feedback such as a motion or a vibration.

The body 212 may also optionally be configured to receive one or more expansion device 244 as desired by a user of the accessory system 210. The expansion device 244 may be any of the aforementioned user interfaces 230 and output devices 240. As non-limiting examples, the user interfaces 230 and the output devices 240, including expansion device 244, may utilize any type of standardized connection, such as capacitive coupling, wireless coupling using any known frequency, and optical coupling.

What is claimed is:

1. An accessory system for a portable electronic computing device, comprising:
a body;
a dock integral with said body for receiving and securing the portable electronic computing device;
a protective case for enclosing at least a portion of the portable electronic computing device when the portable electronic computing device is not attached to the body;
wherein the dock is sized and shaped to receive the portable electronic computing device while the portable electronic computing device is in said protective case.

2. The accessory system of claim 1, further including a secondary coil within said body in electrical communication with the portable electronic computing device, wherein a primary coil may induce a current within said secondary coil for providing power to the portable electronic computing device.

3. The accessory system of claim 1, further including at least one user interface in signal communication with the portable electronic computing device.

4. The accessory system of claim 3, wherein said at least one user interface is one of a button, a rotary knob, a capacitive input device, a voice input device, a video or optical input device, a wireless input device, and a touchpad.

5. The accessory system of claim 3, wherein the at least one user interface is embedded within the body to sense one of motion, direction, force and acceleration.

6. The accessory system of claim 1, further including at least one output device in signal communication with the portable electronic computing device.

7. The accessory system of claim 6, wherein said at least one output device is one of an aural output, a visual output, and a haptic output.

8. The accessory system of claim 1, further including a battery, said battery in electrical communication with the portable electronic computing device.

9. The accessory system of claim 1, wherein said body is configured to receive at least one expansion device, said expansion device in signal communication with the portable electronic computing device

10. An accessory system for a portable electronic computing device, comprising:
a body;
a dock integral with said body for receiving and securing the portable electronic computing device;
a secondary coil within said body in electrical communication with the portable electronic computing device, wherein a primary coil may induce a current within said secondary coil for providing power to the portable electronic computing device; and
wherein the dock is sized and shaped to receive an outer perimeter of the portable electronic computing device to provide impact protection to the portable electronic computing device.

11. The accessory system of claim 10, further including at least one user interface in signal communication with the portable electronic computing device.

12. The accessory system of claim 11, wherein said at least one user interface is one of a button, a rotary knob, a capacitive input device, a voice input device, a video or optical input device, a wireless input device, and a touchpad.

13. The accessory system of claim 11, wherein the at least one user interface is embedded within the body to sense one of motion, direction, force and acceleration.

14. The accessory system of claim 10, further including at least one output device in signal communication with the portable electronic computing device.

15. The accessory system of claim 14, wherein said at least one output device is one of an aural output, a visual output, and a haptic output.

16. The accessory system of claim 10, further including a battery, said battery in electronic communication with the portable electronic computing device.

17. An accessory system for a portable electronic computing device, comprising:
a body;
a dock integral with said body for receiving and securing the portable electronic computing device;
a battery internal to said body, said battery in electronic communication with the portable electronic computing device.
wherein the dock is sized and shaped to receive an outer perimeter of the portable electronic computing device to provide impact protection to the portable electronic computing device.

18. The accessory system of claim 17, wherein said body is configured to receive at least one expansion device, said expansion device in signal communication with the portable electronic computing device.

19. The accessory system of claim 18, wherein said expansion device is one of a user interface, an output device and an external power source.

20. The accessory system of claim 17, further including a secondary coil within said body in electrical communication with the portable electronic computing device, wherein a primary coil may induce a current within said secondary coil for providing power to the portable electronic computing device.
